(19) United States
(12) Patent Application Publication
(10) Pub. No.: US 2026/0131390 A1
(43) Pub. Date: May 14, 2026

(54) CHIP COLLECTION BOX FOR CUTTING TOOL

(71) Applicant: Hilti Aktiengesellschaft, Schaan (LI)

(72) Inventors: Junsong ZHOU, Shanghai (CN); Yu YANG, Shanghai, Songjiang district (CN); Sven GRUMBRECHT, Shanghai (CN); Chuntang GU, Shanghai (CN)

(21) Appl. No.: 19/120,082

(22) PCT Filed: Oct. 13, 2023
(86) PCT No.: PCT/EP2023/078512

§ 371 Date: Apr. 10, 2025

(30) Foreign Application Priority Data
Oct. 26, 2022 (CN) 202211315310.3

(51) Int. Cl. B23D 59/00; B23D 45/16

(52) U.S. Cl. CPC B23D 59/006; B23D 45/16

(57) ABSTRACT

A chip collection box for a cutting tool. The cutting tool includes a cutter for performing a cutting operation and a protective cover at least partially covering the cutter. The chip collection box is attached to the protective cover for receiving chips from a workpiece cut by the cutting tool during the cutting operation, the chip collection box has a dust collecting inlet, a chip collection chamber for receiving the chips, and a dust collecting outlet for discharging the chips. The chip collection box further includes at least one indicator for showing the amount of the chips accumulated in the chip collection chamber. The chip collection box has the indicator capable of showing the amount of the chips or dust accumulated in the chip collection box, so that a user can notice in time whether the chips need to be cleaned.

### TECHNICAL FIELD

The present invention relates to a cutting tool, and in particular to a chip collection box for a cutting tool.

### BACKGROUND ART

Hand-held cutting tools are widely used power tools for cutting workpieces such as wood, metal and many other materials. Typically, the hand-held cutting tools include a variety of power tools having rotary cutters for cutting workpieces to be machined, such as circular saws, angle grinders, planers, etc. During cutting with the above-mentioned cutting tools, the materials removed from the workpieces, such as chips or dust, are scattered due to the rotation of the cutters. Therefore, the cutting tools are generally connected to a chip collection box for collecting flying chips or dust.

### SUMMARY OF THE INVENTION

For a hand-held cutting tool, an appropriate size and weight should be maintained to facilitate a hand-held operation, and accordingly, the chip collection box for the cutting tool should also have a small and delicate structure. When the cutting tool completes multiple cutting operations, the chip collection box attached thereto is gradually fully filled with the accumulated flying chips or dust, or even the chip collection box would have been fully filled during a single cutting operation. In this case, it is necessary to discharge the chips or dust from the chip collection box in time, otherwise the chips may clog in a protective cover of the cutting tool, affecting the normal operations of the cutting tool.

Conventional chip collection boxes are typically made of a non-transparent plastic material, such as PA66-GF35, and it is difficult for a user to directly observe the amount of chips accumulated in the chip collection box from the outside. When the user continues to use the cutting tool without noticing that the chip collection box is already fully filled with the chips, the risk of the chips clogging the cutting tool may occur. An existing chip collection box is provided with a transparent viewing window for observing the amount of chips, but transparency is difficult to achieve due to the fact that the viewing window is often made of PC plastic (polycarbonate). However, although the PC plastic itself is transparent, the interior of a chip collection chamber is dark, both the chip collection chamber and the chips are black or dark grey, and the viewing window looks always black when viewed from the outside, so it is difficult to clearly see the amount of chips accumulated in the chip collection chamber. Furthermore, when the cutting tool performs a high-speed cutting operation, the temperature of the resulting chips is very high, especially for machining metal pieces, and the metal chips at high temperature entering the chip collection chamber will cause the transparent viewing window to be melted or gelatinized, thereby losing the possibility of directly observing the amount of chips accumulated in the chip collection chamber from the outside.

Moreover, even if the user is able to check and clean the waste chips or dust in the chip collection box in time before the chip collection box is full, the user's safety may also be affected if the temperature of the dust is too high in this case.

An object of the present invention is to provide a chip collection box for a cutting tool, which can intuitively show the amount of the chips or dust accumulated in the chip collection box, so as to help a user to notice in time whether cleaning is required.

The present invention provides a chip collection box for a cutting tool. The cutting tool comprises a cutter for performing a cutting operation and a protective cover at least partially covering the cutter. The chip collection box is attached to the protective cover for receiving chips from a workpiece cut by the cutting tool during the cutting operation, the chip collection box has a dust collecting inlet, a chip collection chamber for receiving the chips, and a dust collecting outlet for discharging the chips. The chip collection box comprises at least one indicator for showing the amount of the chips accumulated in the chip collection chamber.

According to an embodiment of the present invention, the indicator changes in colour with temperature inside the chip collection chamber. The indicator is formed of a plastic material containing a temperature-sensitive component that changes in colour with temperature, and the temperature-sensitive component allows a portion of the indicator in contact with the high-temperature chips generated during the cutting operation to change in colour. The temperature-sensitive component is a microcapsule powder coated with an invisible material, a colour-forming agent and a temperature control agent, and a temperature-sensitive colour material that changes in colour in different temperature intervals and can be manufactured by adding the microcapsule powder to the plastic material.

The indicator is constructed as an integral structure of the chip collection chamber. Alternatively, the indicator is at least a part of the chip collection chamber.

The chip collection chamber comprises a first side face facing a side on which an electric motor is mounted, an opposite second side face, a rear end face facing a user, a bottom face substantially facing the cut workpiece, and a top face opposite to the bottom face, wherein the indicator is arranged on the second side face and/or the rear end face. Preferably, the indicator extends continuously upwardly from a position adjacent to the bottom face to a position adjacent to the top face on the second side face and/or the rear end face. Alternatively, the indicators are discretely distributed on the second side face and/or the rear end face to form indication marks indicating the height of the chips accumulated in the integrated chamber.

According to a preferred embodiment of the present invention, the chip collection chamber is further provided with a chip overflow port.

According to another embodiment of the present invention, the indicator comprises a measurement device for measuring the amount of the chips in the chip collection box, and a display device for emitting an optical and/or an acoustic signal according to a measurement result of the measurement device, the display device comprising one or a combination of an LED, indicator lights of different colours, a voice prompt, and a buzzer.

According to the chip collection box for a cutting tool of the present invention, the indicator can accurately show the amount of the chips accumulated in the chip collection chamber in time. In particular, the indicator is a part or the entirety of the chip collection chamber, and the indicator is formed of the temperature-sensitive colour material capable of changing in colour with temperature, so that because of the accumulation of the high-temperature chips in the chip collection chamber, the portion of the indicator formed of the temperature sensitive colour material that is in contact with the high-temperature chips will change in colour, and the user can then clearly know the amount of the high-temperature chips accumulated in the chip collection chamber so as to perform timely cleaning when or before the chip collection chamber is fully filled.

### BRIEF DESCRIPTION OF THE DRAWINGS

A better understanding of the embodiments mentioned can be gained from the following detailed description with reference to the drawings. It is emphasized that the various components are not necessarily drawn to scale. In fact, dimensions may be increased or decreased at will for the purpose of clear description. In the drawings, the same reference numerals refer to the same elements.

FIG. 1 is a schematic overall view of a chip collection box for a cutting tool according to an embodiment of the present invention mounted to the cutting tool;

FIG. 2 is a schematic partial view of the chip collection box for a cutting tool shown in FIG. 1 mounted to the cutting tool;

FIG. 3 is a schematic view of a chip collection box according to an embodiment of the present invention;

FIG. 4 is another schematic view of the chip collection box shown in FIG. 3; and

FIG. 5 is a schematic view of another exemplary chip collection box for a hand-held cutting tool of the present invention.

### DETAILED DESCRIPTION

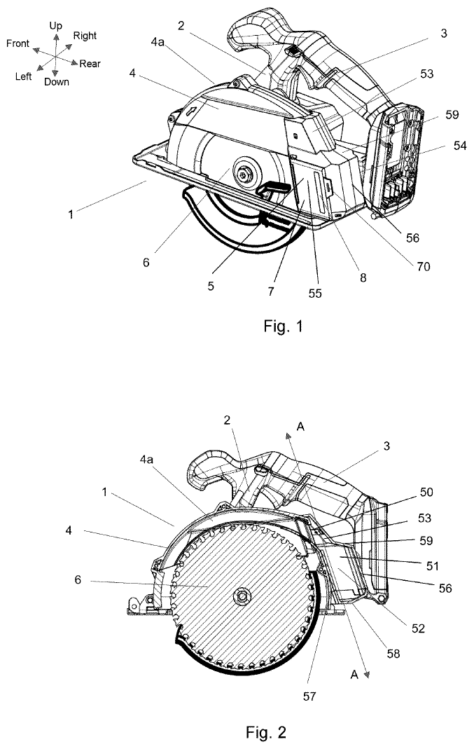

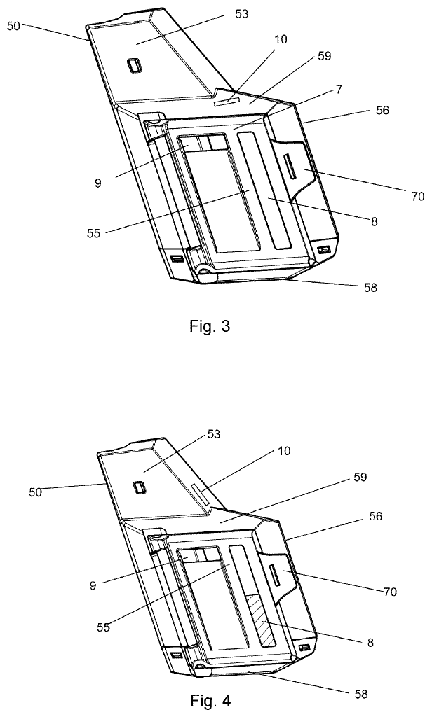

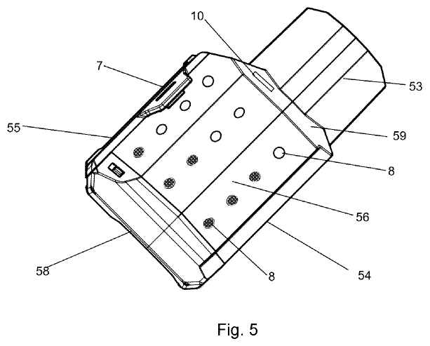

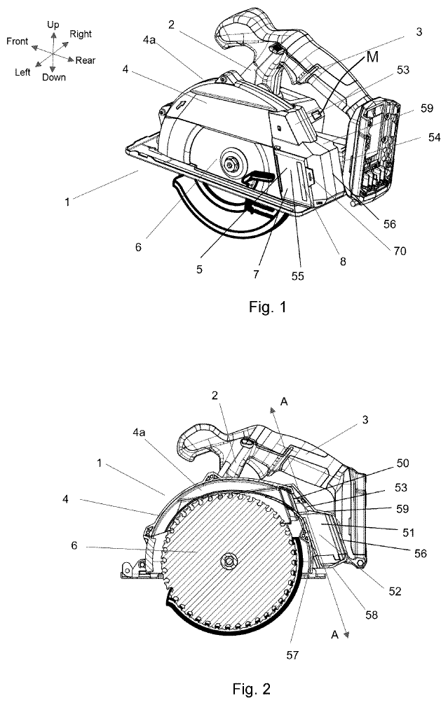

A chip collection box for a cutting tool according to embodiments of the present invention will be described below with reference to FIGS. 1-5. The terms “front”, “rear”, “above”, “below”, “left” and “right” in the present invention are used throughout this description to define various parts of the cutting tool when arranged in an orientation in which it is desired to be used, such as the orientation shown in FIG. 1.

According to an exemplary embodiment of the present invention, the cutting tool includes, but is not limited to, a hand-held circular saw 1. As shown in FIGS. 1-2, the circular saw comprises a housing 2, a handle 3 mounted on the outside of the housing, an electric motor M (shown solely schematically) mounted inside the housing 2, a protective cover 4 at least partially covering the cutting tool 6, and a chip collection box 5 attached to the protective cover 4. As shown in FIG. 2, a chip channel 4a is formed in the protective cover 4, and the chip channel 4b is located substantially above teeth of a cutting blade 6. In this exemplary embodiment, the handle 3 is mounted above the housing 2 adjacent to the right side of the protective cover 4 and is substantially parallel to an operating direction of the circular saw, namely, a front-rear direction. In other embodiments, the electric motor and the handle 3 may also be arranged adjacent to the left side of the protective cover 4. The chip collection box 5 is detachably attached to a rear end of the protective cover 4, for example, by means of a groove structure, the chip collection box 5 slides into a set position from an upper end of the protective cover, namely, being mounted in place, along the groove on the protective cover.

Referring to FIGS. 2 to 4, the chip collection box 5 has a dust collecting inlet 50, a chip collection chamber 51 for receiving chips, and a dust collecting outlet 52 for discharging the chips. When the circular saw 1 performs a cutting operation, a user holds the handle 3, a saw blade cuts a workpiece while moving forwards, during which, chips generated during the cutting of the workpiece are thrown into the dust collecting inlet 50 of the chip collection box 5 along the chip channel in the protective cover 4. A guide channel 53 is provided between the dust collecting inlet 50 and the chip collection chamber 51, and the guide channel 53 is in communication with the dust collecting inlet 50 and the chip collection chamber 51.

The chip collection box 5 of the present invention further comprises at least one indicator 8 for displaying the amount of the chips accumulated in the chip collection chamber to visually and accurately indicate the amount of the chips accumulated in the chip collection chamber. The indicator 8 of the present invention is formed of a plastic material containing a temperature-sensitive component that changes in colour with temperature, and the temperature-sensitive component allows a portion of the indicator in contact with the high-temperature chips generated during the cutting operation to change in colour. Preferably, the temperature-sensitive component is a microcapsule powder coated with an invisible material, a colour-forming agent and a temperature control agent, and a temperature-sensitive colour material that changes in colour in different temperature intervals and can be manufactured by adding the microcapsule powder to the plastic material. For example, such a temperature-sensitive colour material is charcoal grey at room temperature, and when the temperature rises to about 45° C., the temperature control agent in the microcapsule powder begins to function such that the temperature-sensitive colour material becomes reddish, and when the temperature further rises to 60° C., the temperature-sensitive colour material becomes deep red or rosy. The indicator 8 formed of such a temperature-sensitive colour material to which the temperature-sensitive component is added changes in colour with the temperature in the chip collection chamber 51. Prior to the cutting operation by the cutting tool, the chip collection box has no chips therein, so the chip collection box is substantially at normal or room temperature, and as shown in FIG. 3, the whole indicator 8 is charcoal grey in a normal temperature state. When the chips at high temperature generated during the cutting operation pass through the dust collecting inlet 50 and the guide channel 53 and enter the chip collection chamber 51, and are gradually accumulated in the chip collection chamber 51. The chips gradually accumulated in the chip collection chamber 51 in this case remain at a high temperature, for example, above 50° C., or even higher, for example, between 80-100° C. The high-temperature chips are in contact with the indicator 8 formed of the temperature-sensitive colouring material, and the indicator 8 changes from charcoal grey to red, as shown in a lower portion marked with slashes on the indicator 8 in FIG. 4.

In this embodiment, the change in colour of the indicator 8 formed of the temperature-sensitive colour material upon contact with the high-temperature chips is merely illustrative. In practice, by means of selection of different temperature control factor materials, colour materials changing in colour depending on different temperatures can be made. For example, the colour material is green at normal temperature, is yellow at 50° C. and red at 80° C. The advantage of using the microcapsule powder as the temperature-sensitive component is that the microcapsule powder has a good solvent resistance and dispersibility and is suitable for injection moulding.

According to a preferred embodiment of the present invention, the indicator 8 is constructed as an integral structure of the chip collection chamber. The material of the indicator 8 is PA66 added with microcapsule powder. First, the microcapsule powder is added to the PA66 powder with a toner ratio of 0.1-5% before injection moulding. That is to say, the chip collection box is integrally formed by the temperature-sensitive colour material of the present invention, and the temperature-sensitive colour material changes in colour with the temperature. After the chips enter the chip collection chamber 51, the chips will be gradually accumulated in the chip collection chamber from bottom to top. When the cutting operation is not performed, the chip collection chamber 51 is charcoal grey at normal temperature. After the cutting operation begins, the chips first fall at the bottom of the chip collection chamber, so that the temperature of an area at the bottom of the chip collection chamber rises rapidly, and the bottom of the chip collection chamber formed of the temperature-sensitive colour material begins to become red. Furthermore, as more chips enter the chip collection chamber, the height of the chips in the chip collection chamber gradually increases, in this case, a portion of a side wall of the chip collection chamber in contact with the chips also begins to become red while an upper portion of the side wall of the chip collection chamber is still charcoal grey or slightly becomes red, and the upper space of the chip collection chamber is not fully filled with the chips. The user of the cutting tool can thus determine the amount of the chips accumulated in the chip collection chamber according to the change in colour of the side walls of the chip collection chamber. When the chip collection chamber is fully filled with the chips, the entire chip collection chamber shows deep red at high temperature. In this way, the user can easily and visually notice that the chip collection box is full without opening the chip collection box, and the chips need to be discarded in time in order to avoid the risk of chip clogging affecting the operations of the cutting tool.

Alternatively, the indicator 8 is at least a part of the chip collection chamber. For example, a body of the chip collection box is injection-moulded by PA66-GF35, the indicator 8 is formed of PP added with the temperature-sensitive component, and the indicator 8 is formed as part of the chip collection chamber 51 by means of a moulding process such as secondary moulding or insert injection moulding.

According to another preferred embodiment of the present invention, the chip collection chamber 51 comprises a first side face 54 facing the side of the circular saw on which an electric motor is mounted (i.e., the right side in FIG. 1), and a second side face 55 opposite to the first side face 54 (i.e., the left side in FIG. 1), a rear end face 56 facing the user, an engagement face 57 facing the rear end of the protective cover 4, a bottom face 58 substantially facing a workpiece to be cut, and a top face 59 opposite to the bottom face. The chip collection chamber 51 is configured as a generally square cavity having a recess for receiving the rear end of the protective cover. The chip collection box 5 may be mounted to the rear end of the protective cover 4 in direction A-A as shown in FIG. 2. The dust collecting outlet 52 is formed in the second side face 55 of the chip collection chamber, namely, the side facing away from the electric motor and the handle (the left in FIG. 1), and the dust collecting outlet 52 is used for discharging the flying chips or dust accumulated in the chip collection chamber. The dust collecting outlet 52 is opened or closed by means of a pivotable door 7. The door 7 covers the entire second side face and may alternatively be a part of the second side face. The door 7 is further provided with a lock catch 70, the lock catch maintains the door 7 in a closed state when being engaged with the chip collection chamber, and the door 7 can be opened by unlocking the lock catch 70. The dust collecting outlet is opened or closed by means of the pivotable door 7, so that the overall structure of the chip collection box can be made small and concise. Alternatively, the dust collecting outlet may be opened or closed by means of a sliding door or a drawer structure.

The indicator 8 is provided on the second side face 55 and/or the rear end face 56. In fact, the indicator 8 may be provided at any position convenient for showing the amount of the chips in the chip collection chamber and for observation by the user, or a plurality of indicators 8 may be provided on a plurality of side faces respectively.

In the embodiment shown in FIGS. 3 and 4, the indicator 8 is provided on the second side face 55 and extends continuously upwardly from a position adjacent to the bottom face 58 to a position adjacent to the top face 59 on the second side face 55, that is, the indicator 8 extends on the second side face 55 substantially in a vertical direction as shown in FIG. 1. Since the cutting tool is operating as shown in FIG. 1 after the chips enter the chip collection chamber 51, the chips are first accumulated on the bottom face 58, in this case, the bottommost end of the indicator 8 begins to change in colour due to contact with the high-temperature chips, while the remaining portion of the indicator 8 still retains its colour at normal temperature. The high-temperature chips are gradually accumulated upwards, and as shown in FIG. 4, the portion of the indicator 8 in contact with the chips also begins to change in colour. Until the high-temperature chips abut against the top face 59, the indicator 8 is in contact with the high-temperature chips over its entire height, so that the entire indicator changes in colour, and the entire chip collection chamber 51 is fully filled with the high-temperature chips in this case.

Preferably, the indicator 8 has a generally parallelogram shape, is arranged on the door 7 adjacent to the lock catch 70, with the long sides of the parallelogram extending in direction A-A. Such an indicator 8 achieves the function of indicating the amount of chips accumulated in the chip collection chamber in the simplest, convenient and attractive manner. Alternatively, the indicator 8 may also have another shape, such as a curve shape or any shape extending between the top face 59 and the bottom face 58.

According to a preferred embodiment of the present invention, the chip collection box is further provided with a chip overflow port 9. As shown in FIGS. 3 and 4, the chip overflow port 9 may be formed in a end of the second side face 55 close to the top face. When the chips of the chip collection chamber are accumulated up to the height of the chip overflow port 9, at least part of the chips will overflow out of the chip collection chamber through the chip overflow port 9, in order to further prevent excessive accumulation of chips in the chip collection chamber.

More preferably, the chip collection box is further provided with a vent 10. The vent 10 is provided in an outer side wall of the guide channel or the top 59 of the chip collection chamber. Since a high-temperature airflow will be entrained by the high-temperature chips entering the guide channel 33 and the chip collection chamber 51, if there is no vent 9, the high-temperature airflow will cause the ambient temperature in the chip collection chamber to rise, and an excessive increase in the ambient temperature may affect the rate of colour change of the indicator, leading to the user not easily noticing the colour change of the portion of the indicator in contact with the cutting chip. Therefore, the arrangement of the vent 10 is conductive to improving the accuracy of the indicator.

According to another preferred embodiment of the present invention, as shown in FIG. 5, the indicators 8 may not extend continuously, but may be distributed discretely on the second side face and/or the rear end face, and may also form an indication mark for indicating the amount of the chips in the integrated chamber. A plurality of discretely arranged indicators 8 help to show the amounts of chips in the chip collection chamber at different machining angles. When the cutting tool performs a cutting operation at an angle as shown in FIG. 1, the chip collection box is substantially vertical, so the chips are also gradually accumulated in the vertical direction, and the aforementioned indicators 8 extending between the bottom face 58 and the top face 59 has the same orientation as a chip accumulation direction in this case, so that the amount of the chips in the chip collection chamber can be accurately showed. However, the machining direction of the cutting tool is not always in the front-rear direction shown in FIG. 1, for example, when the machining direction of the circular saw 1 shown in FIG. 1 is rotated by 45 degrees, the chip collection box is also arranged at an angle of 45 degrees relative to the vertical direction. As shown in FIG. 5, and the chips generated during the cutting operation will first be accumulated at the lower right corner close to the first side face 54 and the bottom face 58, and gradually pile up from the lower right corner to the upper left corner, so that in the indicators 8 close to the lower right corner region, as indicated by a colour-filled mark 8 in FIG. 5, these indicators 8 will first change in colour. The indicators 8 distributed discretely on the second side face 55 are still able to change in colour gradually with the height of cutting chip accumulated when the chip collection box operates in a non-vertical position, so as to accurately indicate the amount of the chips in the chip collection chamber.

In addition, the indication marks 8 formed of the colour-changeable temperature-sensitive colour material of the present invention also have an advantage that if the indication marks 8 shows a colour at high temperature, such as deep red, indicating that the chips in the chip collection chamber is at very high temperature, and it is not appropriate to immediately open the door for cleaning the chips at the moment, in order to prevent scalding. When the indication marks 8 gradually return to the colour at normal temperature, the chips can be cleaned safely.

According to a further embodiment of the present invention, the indicator comprises a measurement device for measuring the amount of the chips in the chip collection chamber, and a display device for emitting an optical and/or an acoustic signal according to a measurement result of the measurement device, the display device comprising one or a combination of an LED, indicator lights of different colours, a voice prompt, and a buzzer.

As described above, although exemplary embodiments of the present invention have been explained herein with reference to the drawings, the present invention is not limited to the specific embodiments described above, and may have many other embodiments. The scope of the present invention should be defined by the claims and their equivalent meanings.

What is claimed is:

1-10. (canceled)

11. A chip collection box for a cutting tool having a cutter for performing a cutting operation and a protective cover at least partially covering the cutter, the chip collection box being attached to the protective cover for receiving chips from a workpiece cut by the cutting tool during the cutting operation, the chip collection box comprising:
a dust collecting inlet;
a chip collection chamber for receiving the chips;
a dust collecting outlet for discharging the chips; and
at least one indicator for showing an amount of the chips accumulated in the chip collection chamber.

12. The chip collection box as recited in claim 10 wherein the indicator changes in color with a temperature inside the chip collection chamber.

13. The chip collection box as recited in claim 12 wherein the indicator is formed of a plastic material containing a temperature-sensitive component changing in color with temperature, and the temperature-sensitive component allows a portion of the indicator in contact with the high-temperature chips in the chip collection chamber to change in color.

14. The chip collection box as recited in claim 13 wherein the temperature-sensitive component is a microcapsule powder coated with an invisible material, a color-forming agent and a temperature control agent, and a temperature-sensitive color material changing in color in different temperature intervals is manufactured by adding the microcapsule powder to the plastic material.

15. The chip collection box as recited in claim 11 wherein the indicator forms a part of the chip collection chamber.

16. The chip collection box as recited in claim 11 wherein the indicator forms an entirety of the chip collection chamber.

17. The chip collection box as recited in claim 11 wherein the chip collection chamber comprises a first side face facing a side where an electric motor is mounted, an opposite second side face, a rear end face facing a user, a bottom face facing the cut workpiece, and a top face opposite to the bottom face, the indicator being arranged on the second side face or the rear end face.

18. The chip collection box as recited in claim 17 wherein the indicator extends continuously upwardly from a first end adjacent to the bottom face to a second end adjacent to the top face, on the second side face or the rear end face.

19. The chip collection box as recited in claim 17 wherein the indicators are discretely distributed on the second side face or the rear end face to form indication marks indicating a height of the chips accumulated in the integrated chamber.

20. The chip collection box as recited in claim 11 wherein the chip collection chamber is provided with a chip overflow port.

21. The chip collection box as recited in claim 11 wherein the indicator includes a measurement device for measuring the amount of the chips in the chip collection box, and a display device for emitting an optical or an acoustic signal according to a measurement result of the measurement device, the display device including one or a combination of an LED, indicator lights of different colors, a voice prompt, and a buzzer.
